(19) United States
(12) Patent Application Publication
(10) Pub. No.: US 2007/0247010 A1
(43) Pub. Date: Oct. 25, 2007

(54) MOTOR

(75) Inventor: Hiroyuki ICHIZAKI, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Minami-ku (JP)

(21) Appl. No.: 11/736,668

(22) Filed: Apr. 18, 2007

(30) Foreign Application Priority Data
Apr. 21, 2006 (JP) 2006-118224

(51) Int. Cl. H02K 7/00; H02K 11/00; H02K 3/00

(52) U.S. Cl. 310/71; 310/67 R; 310/179

(57) ABSTRACT

A motor includes a circuit board having a bottom facing surface and a plurality of connecting land portions provided thereon. The circuit board includes a through hole for allowing a wire to extend therethrough. An attachment board makes contact with the bottom facing surface of the circuit board. The attachment board includes an opening portion penetrating the attachment board. The wire is wound around a stator core arranged above or equal to the circuit board in an axial direction so as to form a coil. The wire extending from the stator core is soldered to the connecting land portion. The opening portion of the attachment board is arranged at a position such that it makes no direct contact with the wire.

### BACKGROUND OF THE INVENTION

1. Field of the Invention

The present invention relates to a motor in which a circuit board is arranged below a rotor unit, and more particularly, to a motor that is suitable for a driver of a detachable disk drive unit.

2. Description of the Related Art

Hereinafter, a basic configuration of a motor in which a circuit board is arranged below a rotor unit will be described with reference to FIGS. 7 to 10.

FIG. 7 is a cross sectional view of a conventional motor. FIG. 8 is a cross sectional view of another conventional motor. FIG. 9 is an enlarged view of an area surrounding a connecting land portion of the motor shown in FIG. 8. FIG. 10 is a cross sectional view of yet another conventional motor.

According to FIGS. 7 to 10, a cylindrically shaped bush 100 is affixed to a fixing hole portion 104 provided in an attachment board 102. A bearing 106 is arranged at an inner circumferential surface of the bush 100. The bearing 106 rotatably supports a shaft 108 centered about a central axis 110. A cylindrically shaped, operculated rotor holder 112 is arranged at an axially upper portion of the shaft 108. A substantially annular shaped rotor magnet 114 is located at an inner circumferential surface of the rotor holder 112. A stator core 118 includes a substantially annular shaped core back portion 120 and a plurality of tooth portions 122 each extending from the core back portion 120 in a radial direction. An inner circumferential surface of the core back portion 120 is arranged at an outer side circumferential surface of the bush 100. An outer circumferential surface of each tooth portion 122 and an inner circumferential surface of the rotor magnet 114 are opposed to one another via a gap disposed therebetween in the radial direction. A wire is wound around each tooth portion 122 so as to form a coil 124 around each tooth portion 122. A stator 126 includes the stator core 118 and the plurality of coils 124. A circuit board 128 is physically affixed to the attachment board 102. The wire extending from the stator 126 is soldered by using a solder 132 to the connecting land portion 130 of the circuit board 128.

Conventionally, there are three types of connecting methods for connecting the wire extending from the stator 126 and the connecting land portion 130 of the circuit board 128 in a motor such as one described above.

According to FIG. 7, in a first configuration of the connecting method between the wire and the connecting land portion 130, the circuit board 128 is arranged below the attachment board 102 and the wire is connected to the connecting land portion 130, which is arranged on a bottom facing surface of the circuit board 128. According to FIGS. 8 and 9, in a second configuration of the connecting method between the wire and the connecting land portion 130, the circuit board 128 is arranged above the attachment board 102, and includes the connecting land portion 130 which is arranged above the circuit board 128 and is exposed in a space between two adjacent tooth portions 122.

According to FIG. 10, in a third configuration of the connecting method between the wire and the connecting land portion 130, the connection is made between the connecting land portion 130 and the wire, wherein the circuit board 128 is arranged above the attachment board 102 and includes the connecting land portion 130 which is arranged above the circuit board 128 and outside with respect to the central axis of the rotor holder 112.

However, according to the aforementioned first configuration, the connecting land portion 130, the solder 132 and a portion of the wire are exposed to the lower portion of the motor. By virtue of such configuration, the portion of the wire may be damaged due to the exposure. Further, a short circuit may be caused when the connecting land portion 130 makes a contact with another conductive element (e.g., an element of electronic equipment). Further, since the circuit board 128 and the solder 132 are arranged below the attachment board 102, the motor has an additional thickness in the axial direction as indicated as 136.

Also, according to the aforementioned second configuration, since the connection between the connecting land portion 130 and the wire is made via the solder 132 from an upper side of the stator 126, connecting the two elements will be difficult. In particular, when working with a motor having a small diameter, the space between the adjacent tooth portions 122 is small and therefore, connecting the two elements will be difficult.

Also, according to the aforementioned third configuration, the wire is connected to the connecting land portion 130 via a space between the circuit board 128 and the rotor magnet 114, as well as a space between the circuit board 128 and the rotor holder 112. Therefore, a distance 138 (see FIG. 10) needs to be provided in the aforementioned space so as not to let the wire interfere with the rotating portion of the motor. On the other hand, the distance 138 adds an additional thickness to the motor in the axial direction. Furthermore, foreign objects may enter through the wide space provided at the distance 138, whereby the motor's capability may be hampered (i.e., a short circuit may be caused and/or the bearing may be locked).

### SUMMARY OF THE INVENTION

In order to overcome the problems described above, preferred embodiments of the present invention provide a motor including a rotor portion rotating about a predetermined central axis, and a stator portion including a bearing unit rotatably supporting the stator portion. The stator portion includes a stator including a coil arranged to define a portion of a rotating magnetic field that is generated when electricity is conducted to the stator portion. Also, the stator portion includes a circuit board that is arranged at the same position as the stator in an axial direction or arranged below the stator in the axial direction. The circuit board includes a connecting land portion to which a wire is electrically connected. An attachment board is arranged axially below the circuit board. An opening portion for avoiding contact between the attachment board and the wire is arranged at the attachment board. The circuit board has arranged thereon a through hole in the axial direction through which the wire is lead. The connecting land portion is arranged at a bottom surface of the circuit board. A connection is made between the connecting land portion and the wire. By virtue of such configuration, the connection between the connecting land portion and the wire is made within the axial space of the attachment board, and therefore, the motor achieves a desirable axial thickness. Also, the connecting land is outwardly exposed when viewed from the attachment board, and therefore, the wire is easily soldered thereto.

Other features, elements, processes, steps, characteristics and advantages of the present invention will become more apparent from the following detailed description of the preferred embodiments of the present invention with reference to the attached drawings.

### BRIEF DESCRIPTION OF THE DRAWINGS

FIG. 1 is a schematic cross sectional view of a motor according to a first preferred embodiment of the present invention.

FIG. 2 is an enlarged diagram of the motor according to the first preferred embodiment of the present invention.

FIG. 3 is a bottom plan view of the motor according to the first preferred embodiment of the present invention.

FIG. 4 is a bottom plan view of a motor according to a second preferred embodiment of the present invention.

FIG. 5 is a cross sectional view of a motor according to a third preferred embodiment of the present invention.

FIG. 6 is a cross sectional view of a disk drive device having the motor according to a preferred embodiment of the present invention.

FIG. 7 is a schematic cross sectional view of a conventional motor.

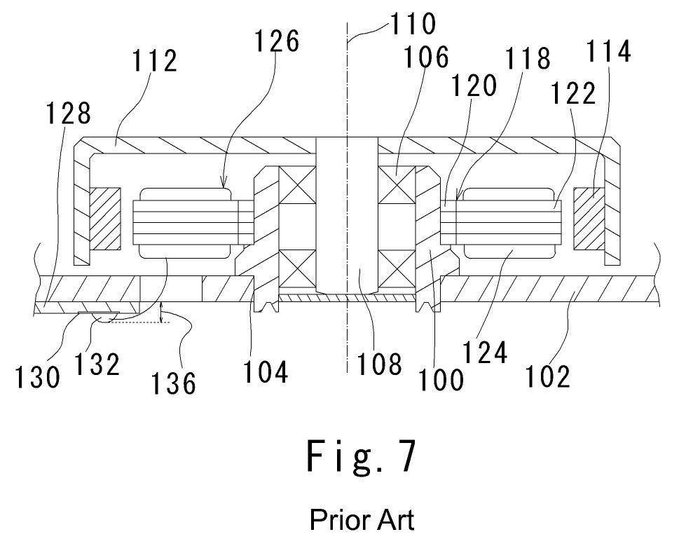

FIG. 8 is a schematic cross sectional view of another conventional motor.

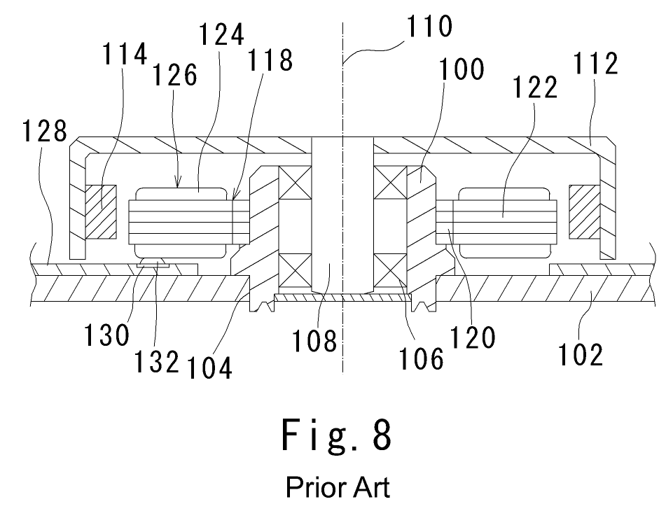

FIG. 9 is an enlarged view of an area including a connecting land portion shown in FIG. 8.

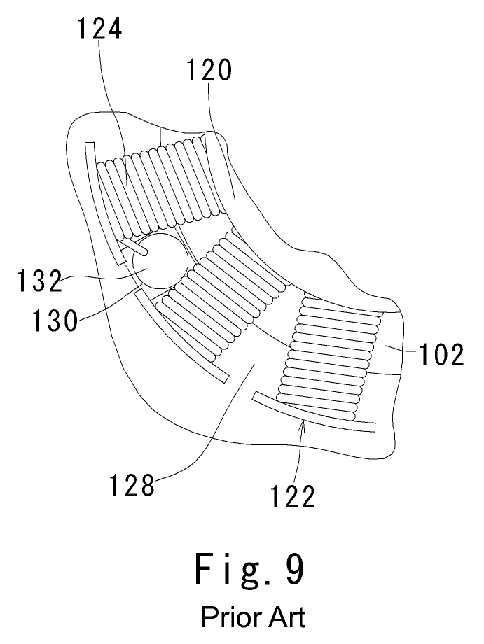

FIG. 10 is a schematic cross sectional view of yet another conventional motor.

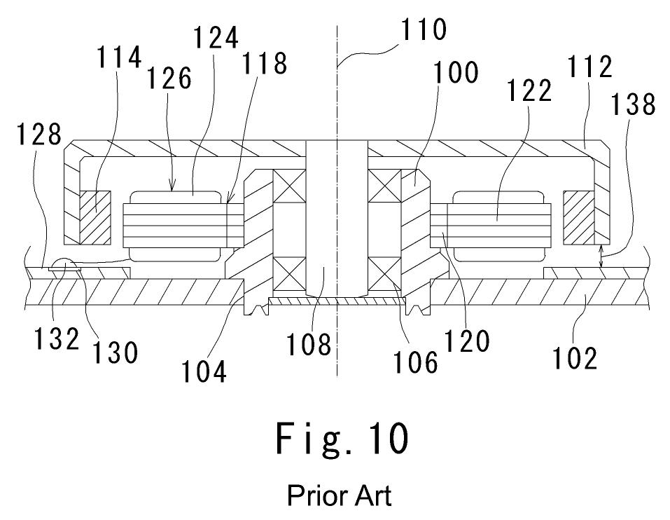

### DETAILED DESCRIPTION OF PREFERRED EMBODIMENTS

Note that in the description of the preferred embodiments of the present invention herein, words such as upper, lower, left, right, upward, downward, top and bottom for describing positional relationships between respective members and directions merely indicate positional relationships and directions in the drawings. Such words do not indicate positional relationships and directions of the members mounted in an actual device. Also note that reference numerals, figure numbers and supplementary descriptions are shown below for assisting the reader in finding corresponding components in the description of preferred embodiments below to facilitate the understanding of the present invention. It is understood that these expressions in no way restrict the scope of the present invention.

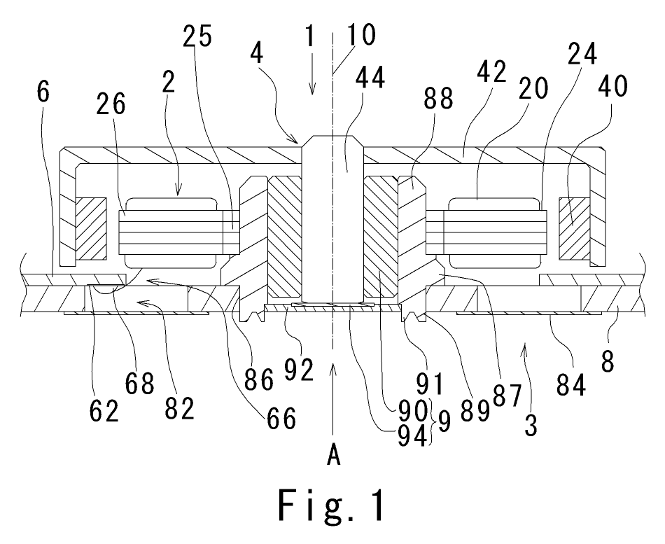

Hereinafter, a first preferred embodiment of a motor 1 according to the present invention will be described with reference to FIGS. 1 to 3. As shown in FIG. 1, the motor 1 includes a stator portion 3 and a rotor portion 4. The stator portion 3 includes a stator 2, a circuit board 6, an attachment board 8, a bush 88, a sleeve 90, a thrust plate 92 and a thrust washer 94.

The rotor portion 4 includes a rotor magnet 40, a rotor holder 42 and a shaft 44. The rotor portion 4 rotates centered about a central axis 10.

Hereinafter, a structure of the stator portion 3 will be described.

According to FIG. 1, the substantially cylindrically shaped bush 88 includes a flange 87, which is arranged at a mid portion in the axial direction of the bush 88 and extends in the radial direction. Also, the bush 88 includes at a bottom portion thereof an outer side deformation portion 89 and an inner side deformation portion 91 each protruding downward from a bottom surface of the attachment board 8 in the axial direction. A portion of the bush 88 below the flange 87 is inserted through a fixing hole 86 which is arranged at a substantially center of the attachment board 8. A bottom surface of the flange 87 in the axial direction makes contact with a top surface of the attachment board 8. The protruding portion of the outer side deformation portion 89 is bent radially outward so as to make a contact with the bottom surface of the attachment board 8. The bush 88 is affixed in a substantially perpendicular manner to the attachment board 8 by crimping wherein the attachment board 8 is sandwiched between the outer side deformation portion 89 and the bottom surface of the flange 87.

The sleeve 90 is preferably substantially cylindrically shaped and is shorter in the axial direction than the bush 88. An outer circumferential surface of the sleeve 90 is press fitted to an inner circumferential surface of the bush 88. The sleeve 90 is made of a sintered material impregnated with oil. The substantially discoid shaped thrust plate 92 is arranged axially below the sleeve 90. The thrust plate 92 is fitted to the inner circumferential surface of the bush 88. The inner side deformation portion 91 is bent inward whereby thrust plate 92 is affixed to the bush 88. The substantially discoid shaped thrust washer 94 having a smaller diameter than that of the thrust plate 92 is arranged axially above the thrust plate 92, which is preferably made of a steel material. The thrust washer 94 is preferably made of a material (e.g., polyetheretherkentone, “PEEK”) having a superior tribological quality and abrasion quality.

The stator 2 includes a stator core 24 and a plurality of coils 20. The stator core 24 includes a plurality of magnetic plates laminated on top of another. The stator core 24 includes an annular shaped core back portion 25 and a plurality of tooth portions 26 each extending in the radial direction from the core back portion 25. The stator 2 is arranged such that an inner circumferential surface of the core back portion 25 is secured to an upper portion of the outer circumferential surface of the bush 88. The wire is wound around each tooth portion 26 so as to form the coil 20.

The motor 1 according to the present preferred embodiment is preferably a three-phase motor arranged in a star configuration for three wires respectively constituting U, V and W phases.

The attachment board 8, which is preferably formed by a press working process, is a plate like member secured to a disk drive device (not shown). The circuit board 6 is in contact with a top surface of the attachment board 8 in the axial direction via an insulating member (not shown). A connecting land portion 62 having arranged thereon a copper foil is arranged axially below the circuit board 6. The wires 68 are soldered to the connecting land portion 62. When the motor is motion, electricity is supplied from an external power supply to the coils 20 via a wiring pattern 63 on the circuit board 6 and the connecting land portion 62.

Hereinafter, a structure of the rotor portion 4 will be described.

The shaft 44, which is longer in the axial direction than the sleeve 90, rotates about the central axis 10. A bottom end in the axial direction of the shaft 44 makes contact with the thrust washer 94. The operculated and substantially cylindrically shaped rotor holder 42 is arranged at an upper portion in the axial direction of the shaft 44. The rotor holder 42 is arranged such that the rotor holder 42 surrounds the stator 2. The substantially cylindrically shaped rotor magnet 40 is arranged at an inner circumferential surface of the cylindrical portion of the rotor holder 42. The rotor magnet 40 is opposed to the stator 2 via a gap therebetween.

When electricity is conducted to the coil 20, a rotating magnetic field is generated in the stator 2. Then, a driving force is, due to a magnetic effect between the stator 2 and the rotor magnet 40, generated in the rotor portion 4. A load imposed on the shaft 44 in the radial direction is supported by the sleeve 90. A load imposed on the shaft 44 in the thrust direction is supported by the thrust washer 94. By virtue of such configuration, the stator portion 3 rotatably supports the rotor portion 4 in a configuration centered about the central axis. Note that in the present preferred embodiment, the sleeve 90 and the thrust plate 92 which collectively support the shaft 44 will be referred to as a bearing unit 9.

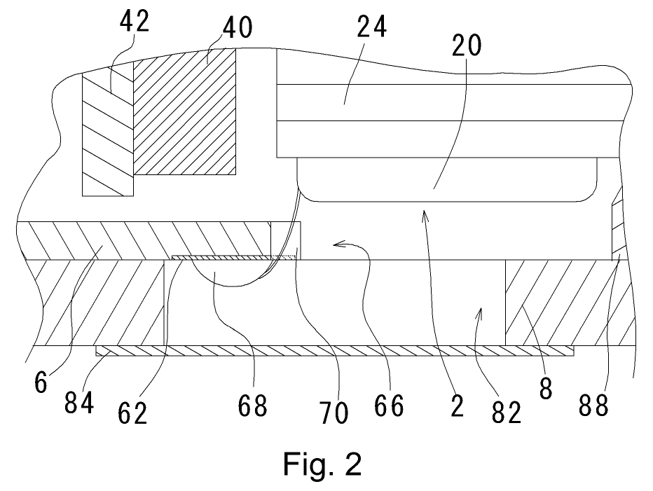

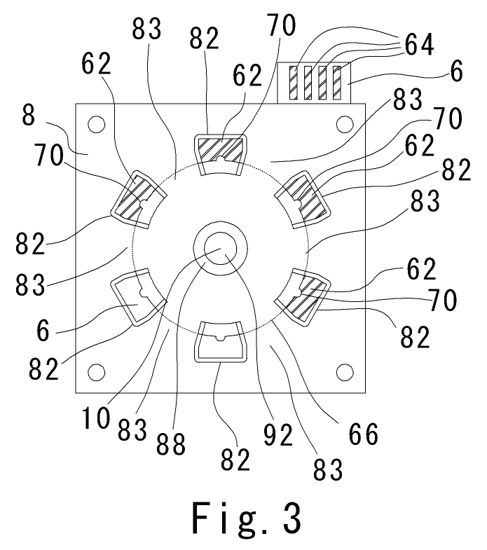

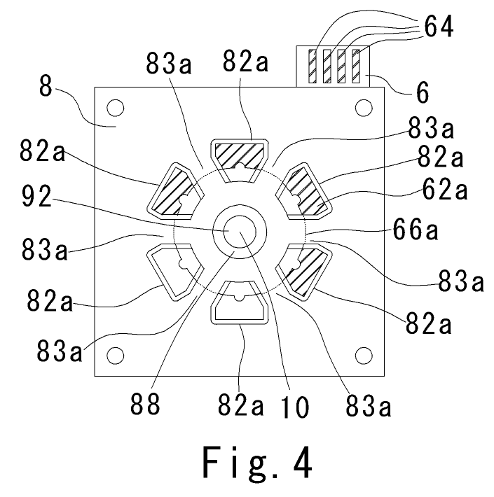

Hereinafter, a structure of the circuit board 6 in which the wires extending from the stator 2 are connected to the connecting land portion 62, and the structure of the attachment board 8, which makes contact with the circuit board 6, will be described with reference to FIGS. 2 to 5. Note that dashed lines depicted in FIGS. 3 and 4 each indicate a hole 66 provided in the circuit board 6.

According to FIG. 2, a plurality of opening portions 82 each penetrating the attachment board 8 in the axial direction are radially arranged at substantially same positions as the coil 20 and circumferentially arranged in an evenly spaced manner. A through hole 66 penetrating the circuit board 6 in the axial direction is arranged centering about the central axis 10 at the circuit board 6. The connecting land portions 62 are arranged below the circuit board 6 and extending radially outward of an outer edge of the through hole 66. Preferably, a total of four connecting land portions 62 are provided so as to correspond with four wires (i.e., U, V, W phases and a common line binding three phases together). At least a portion of each connecting land portion 62 overlaps with the opening portion 82 in the radial direction and is exposed axially downward. The wires are correspondingly soldered to the connecting land portions 62 via the through hole 66 and the opening portion 82.

The wire extending from the stator 2 is connected to the connecting land portions 62 axially above the bottom facing surface of the attachment board 8. A solder 68 that is used for connecting the wire and the connecting land portion 62 is arranged at a position axially above the bottom facing surface of the attachment board 8. By virtue of such configuration, an axial space provided at the attachment board 8 can be effectively used for connecting the wire and the connecting land portion 62, and therefore, the motor achieves a desirable axial thickness.

It is preferable that the circuit board 6 is made of a rigid material such as paper phenol, paper epoxy or glass epoxy in order to maintain the stable contact between the circuit board 6 and the attachment board 8. It is however, needless to say that the circuit board 6 can be made of a flexible material.

Also, it is preferable that an electronic component (not shown) which will be arranged at the top surface of the circuit board 6 is arranged radially outward of the rotor holder 42, and therefore, a perimeter of the through hole 66 is arranged within the cylindrical portion in the radial direction of the rotor holder 42. By virtue of such configuration, the axial space between the bottom end of the cylindrical portion of the rotor holder 42 and the top surface of the circuit board 6 can be minimized, thereby preventing a foreign object from entering therein.

According to FIG. 3, a notch 70 is arranged to extend in the radial direction from a portion of an edge of the through hole 66 corresponding with each connecting land portion 62. At least a portion of the connecting land portion 62 is exposed outward in the axial direction. The wire extending from the tooth portion 26 is connected to the connecting land portion 62 via the notch 70. By virtue of such configuration, the wire will be easily and reliably soldered to the connecting land portion 62, thereby improving work efficiency. Also, since the notch 70 is arranged between the connecting land portion 62 and the stator 2, an amount of copper used for the wire will be minimized.

Hereinafter, a reason for evenly arranging the opening portions 82 in the circumferential direction on the attachment board 8 will be described. If the plurality of opening portions 82 are arranged circumferentially in a non-even manner, a size of a rib portion 83 which is arranged between two adjacent opening portions 82 will be uneven, whereby a force generated due to crimping will be distributed unevenly and damage or deform the attachment board 8. According to the present preferred embodiment, however, since the opening portions 82 are arranged evenly in the circumferential manner, the force generated due to crimping will be distributed evenly to the attachment board 8, and therefore, the damage or deformation to the attachment board 8 will be minimized. Consequently, the shaft 44 will be arranged perpendicular with respect to the attachment board 8.

Hereinafter, a modification of a relationship between the attachment board 8 and the circuit board 6 will be described with reference to FIG. 4. In FIG. 4, while elements similar to those illustrated in FIG. 3 are denoted by similar reference numerals, elements having a different configuration are denoted by similar reference numerals with an “a” suffixed thereto.

According to FIG. 4, it is preferable that each of a plurality of opening portions 82a is formed such that the farther a portion thereof is from the central axis 10, the wider it becomes. By virtue of such configuration, the wire will be easily and reliably soldered to a connecting land portion 62a, thereby improving work efficiency. Also, a portion of the attachment board 8 between the opening portions 82a near the central axis 10 in which a space between each opening portion 82a is wide, a rib portion 83a will have a sufficient space. Also, a through hole 66a having a smaller diameter than that of the through hole 66 shown in FIG. 3 may be provided on the attachment board 8, wherein the connecting land portions 62a and the opening portions 82a arranged surrounding the through hole 66a are arranged accordingly with respect to the smaller diameter of the through hole 66a (i.e., the connecting land portions 62a and the opening portions 82a are arranged nearer to one another).

Referring back to FIG. 2, the sealing member 84 (not shown in FIGS. 3 and 4) preferably having a sheet shape is arranged at the bottom surface of the attachment board 8 so as to seal the opening portion 82, thereby preventing a foreign object from entering in the motor 1. The sealing member 84 is affixed to the attachment board 8 preferably by an adhesive. Also, the sealing member 84 prevents the wire and the connecting land portions 62 from coming into contact with another element of the disk drive device (not shown) and a foreign object. Also, the sealing member 84 prevents the wire and the solder 68 from coming into contact with another element of the disk loading portion during an assembly of the motor 1.

Also, since the sealing member 84 is affixed to the attachment board 8 by the adhesive, the sealing member 84 is readily removable. By virtue of such configuration, a connection status between the connecting land portion 62 and the wire can be examined easily.

Note that the sealing member 84 is not limited to the aforementioned sheet shape but can be a film shape, a plate shape or the like.

Note that the sealing member 84 can be in a form of adhesive or resin. When the adhesive or the resin is used as the sealing member 84, the opening portion 82 is filled by the adhesive or the resin.

A portion of the circuit board 6 protrudes in the radial direction from the edge of the attachment board 8. An external connecting land portion 64 is arranged at the protruding portion of the circuit board 6 to which electricity is supplied. The external connecting land portion 64 is electrically connected to the connecting land portion 62 via the wiring pattern 63 arranged on an insulating layer 65. The external connecting land portion 64 is connected to a connector (not shown) via which the electricity is supplied to the coil 20.

Since the external connecting land portion 64 is arranged on a same surface as the connecting land portion 62, the external connecting land portion 64, the connecting land portion 62 and the wiring pattern 63 can be arranged on a side of the circuit board 6, and therefore, the configuration of the circuit board 6 will be simplified.

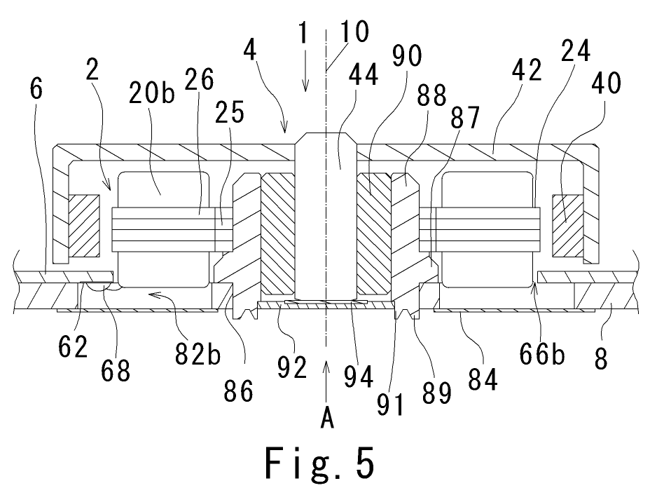

Hereinafter, a second preferred embodiment of the present invention will be described with reference to FIG. 5. FIG. 5 shows a configuration of a motor substantially identical as that shown in FIG. 1. In FIG. 5, while elements similar to those illustrated in FIG. 1 are denoted by similar reference numerals, elements having a different configuration are denoted by similar reference numerals with a “b” suffixed thereto.

According to the second preferred embodiment, the outer circumferential edge of a through hole 66b is arranged radially outward of an outer circumferential edge of a coil 20b. Also, an outer circumferential edge of an opening portion 82b of the attachment board 8 is arranged radially outward of the outer circumferential edge of the coil 20b. Also, an inner circumferential edge of the opening portion 82b is arranged radially inward of the inner circumferential edge of the coil 20b. Also, a number of the opening portions 82b is equal to a number of tooth portions 26. Also, the opening portions 82b each are arranged so as to correspond to each tooth portion 26. By virtue of such configuration, when the coils 20b are made in the same manner as those in the first preferred embodiment, the stator 2 can be arranged at a position axially lower than that in the first preferred embodiment, thereby allowing the motor 1 to achieve the desirable thickness.

Further, according to the present preferred embodiment, an insulating member 67 which is formed by hardening an adhesive or the like is arranged between the bottom facing surface of the circuit board 6 and the top surface of the attachment board 8. Since the insulating member 67 is made of the adhesive, a wiring pattern 63b is insulated by the adhesive. Also, the adhesive connects the circuit board 6 and the attachment board 8. By the virtue of such configuration, the configuration of the circuit board 6 will be simple.

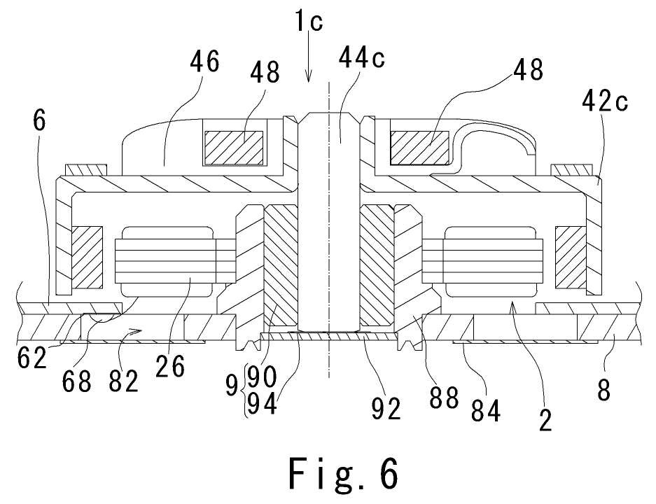

Hereinafter, the motor according to various preferred embodiments of the present invention used in an optical disk drive will be described with reference to FIG. 6. FIG. 6 shows a configuration substantially identical as that shown in FIG. 1. In FIG. 5, while elements similar to those illustrated in FIG. 1 are denoted by similar reference numerals, elements having a different configuration are denoted by similar reference numerals with a “c” suffixed thereto.

According to a motor 1c of the present preferred embodiment, an outer circumferential surface of an upper portion of a shaft 44c is attached to an inner circumferential surface of the cylindrical portion extending upward in the axial direction of the rotor holder 42c. Also, a center case 46 is fittingly affixed to a top surface of the rotor holder 42c. For example, an optical disk (e.g., CD and/or DVD) (not shown) having a central through hole portion is fittingly affixed to the center case 46, wherein the inner circumferential surface of the central through hole portion of the optical disk is fitted to the center case 46. To be more specific, the optical disk is loaded on a disk loading portion arranged on the top surface of the rotor holder 42c, and is retained by a chucking device arranged on the disk drive device (not shown). According to the present preferred embodiment, a clamp magnet 48 is arranged inside the center case 46. When loading the optical disk on the motor 1 according to the present preferred embodiment, the clamp magnet 48 magnetically attracts a damper (not shown), which is arranged axially above the clamp magnet 48. The clamp magnet 48 and the damper define a chucking mechanism. The disk loading portion arranged above the rotor holder 42c retains the optical disk by using the magnetic force of the clamp magnet 48.

When loading the optical disk to and/or removing the optical disk from the disk loading portion, a foreign object may enter inside the disk drive device. However, according to the motor 1 of the present preferred embodiment, a space between the rotor holder 42c and the circuit board 6 is very small, and the opening portion 82 of the attachment board 8 is sealed by the sealing member 84. Therefore, there is a smaller chance that the foreign object can enter the space between the rotor holder 42c and the circuit board 6. The bearing portion 9 is arranged inside the rotor holder 42c.

The motor 1 according to the present preferred embodiment is suitable for use in a portable apparatus such as a portable music device, a portable game device or the like.

Hereinafter, a connection procedure of the wire and the connecting land portion 62 of the circuit board 6 according to the present preferred embodiment will be described. The connecting procedure preferably includes a winding step, an adhesion step, a soldering step and a sealing step.

In the winding step, three wires (i.e., one wire for U phase, V phase and W phase) each are wound around the corresponding tooth portion 26 so as to form the coils 20.

In the adhesion step, the inner circumferential surface of the core back portion 25 and an outer circumferential surface of the bush 88 are affixed to one another via an adhesive. Prior to the adhesion step, the bush 88 and the attachment board 8; the attachment board 8 and the circuit board 6; and the bush 88 and the sleeve 90, are respectively affixed to one another.

At least either one of the stator 2 and the bush 88 has applied thereon the adhesive on the contacting surface. Then, the core back portion 25 is inserted into the bush 88, wherein the inner circumferential surface of the core back portion 25 and the outer circumferential surface of the core back portion 25 come into contact with one another. Then, the wires extending from the stator 2 each are lead to the opening portion 82 arranged by the connecting land portion 62 corresponding to the wire, whereby the position of the stator 2 in the circumferential direction with respect to the bush 88 is determined.

After the adhesive is hardened, the motor 1 is turned upside down in the axial direction so as to allow an easy access to the connecting land portions 62.

In the soldering step, the wires are soldered to the corresponding connecting land portion 62. The wires extending from the stator 2 are soldered to the corresponding connecting land portion 62 via the corresponding notched portion 70. By virtue of such configuration, the wires are not stretched by any element of the motor 1, and therefore the wires soldered to the connecting land portions 62 are less likely to be snapped off the connecting land portions 62.

The sealing step includes attaching the sealing member 84 to the bottom surface of the attachment board 8, or filling the opening portion 82 with the sealing member 84. Since the opening portion 82 is either sealed by or filled with the sealing member 84, foreign objects are much less likely to enter the rotor holder 42 through the opening portion 82.

Note that although according to the above described preferred embodiments, the motor 1 of the present invention preferably has no mechanism (e.g., C-ring or O-ring) provided to the bush 88, the sleeve 90, the shaft 44 or the rotor holder 42 to secure the connecting between the aforementioned components, such mechanism may be provided.

Also, although the circuit board 6 described above is preferably single-sided, this is not limited thereto. The circuit board 6 may be dual-sided. Note, however, it is preferable to have the single-sided circuit board in order to simplify the structure of the motor 1.

Also, although it is described that only one through hole 66 is arranged on the circuit board 6, there may be a plurality of through holes 66.

Also, although it is described that the opening portions 82 are circumferentially arranged in the even manner with respect to the central axis 10, the present invention is not limited thereto. The opening portions 82 may be arranged in a non-even manner.

Also, the outer diameter of the through hole 66 may be greater than the outer diameter of the rotor holder 42. Also, all components arranged on the circuit board 6 may be arranged radially outward of the rotor holder 42. By virtue of such configuration, the rotor holder 42 may be arranged nearer to the attachment board 8, whereby the rotor portion 4 is allowed to be arranged nearer to the attachment board 8, consequently allowing the motor 1 to be thinner in the axial direction.

Also, although it is described that the motor 1 is preferably the three-phase motor, the motor 1 is not limited thereto. The motor 1 may be a two-phase motor, four-phase motor or the like.

Also, although it is described that the motor 1 has applied thereon the star configuration, the motor 1 is not limited thereto. The motor 1 may have a delta connection, in which the motor 1 has three connecting land portions 62.

Also, although it is described that the notched portions 70 each extending in the radial direction are arranged at the portion of the edge of the through hole 66, the notched portions 70 need not be arranged. As shown in FIG. 5, when the wires extending from the stator 2 are arranged at the same level as the circuit board 6 in the axial direction or below the circuit board 6, the notched portions 70 need not be arranged.

Also, although it is described that the shaft 44 of the motor 1 rotates, the shaft 44 may be fixed.

Also, although it is described that the load imposed on the shaft 44 in the radial direction is supported by the sleeve 90, and the load in the axial direction is supported by the thrust washer 94, the present invention is not limited thereto. The load imposed on the shaft 44 may be supported by a ball bearing mechanism. Also, the rotor portion may be supported by a fluid dynamic bearing or by an air bearing mechanism.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A motor comprising:
a rotor portion concentric with a rotational axis; and
a stator portion including a bearing unit arranged to rotatably support the rotor portion, the stator portion including:
a stator having a plurality of wires arranged to generate a portion of a rotating magnetic field when an electric current is conducted therethrough;
a circuit board arranged at a same position in an axial direction as the stator or at a position axially below the stator, the circuit board having a plurality of connecting land portions arranged to electrically connect the wires and the circuit board; and
an attachment board arranged axially below the circuit board; wherein
the circuit board has a through hole in the axial direction arranged to allow the wires to extend therethrough;
the plurality of connecting land portions are arranged on a bottom facing surface of the circuit board; and
the attachment board has at least one opening portion arranged to avoid a contact with the wires.

2. The motor according to claim 1, wherein a substantially flat top surface of the attachment board opposed to the circuit board in the axial direction is substantially parallel to the circuit board, and the top surface of the attachment board makes contact with a bottom surface of the circuit board.

3. The motor according to claim 1, wherein a substantially flat top surface of the attachment board opposed to the circuit board in the axial direction is substantially parallel to the circuit board, a wiring pattern is arranged at the bottom surface of the circuit board, and a top surface of the attachment board and the bottom surface of the circuit board make contact with one another via an insulating layer.

4. The motor according to claim 1, wherein the plurality of connecting land portions are arranged at an inner side of the at least one opening portion of the attachment board, and the plurality of connecting land portions are arranged at a bottom surface of the circuit board.

5. The motor according to claim 1, wherein the circuit board has arranged thereon a copper foil arranged to define each of the plurality of connecting land portions, and the wires are correspondingly fixed by a solder to the each of the plurality of connecting land portions.

6. The motor according to claim 4, wherein the circuit board has arranged thereon a copper foil arranged to define each of the plurality of connecting land portions, and the wires are correspondingly fixed by a solder to the each of the plurality of connecting land portions.

7. The motor according to claim 1, wherein the at least one opening portion of the attachment board is filled with a sealing member to seal the at least one opening portion.

8. The motor according to claim 1, wherein a sheet shaped sealing member is arranged at a bottom surface of the attachment board to seal the at least one opening portion.

9. The motor according to claim 1, wherein a lowermost portion of the wires are above a bottom surface of the attachment board in the axial direction.

10. The motor according to claim 1, wherein the at least one opening portion includes a plurality of opening portions which are centered about the rotational axis and are substantially evenly spaced apart from one another.

11. The motor according to claim 10, wherein a number of the at least one opening portion is greater than a number of the connecting land portions.

12. The motor according claim 10, wherein the stator includes a stator core having an annular shaped core back portion, a plurality of tooth portions each extending from the core back portion in a radial direction, and a coil defined by multiply winding the wires correspondingly around each of the plurality of tooth portions, and a portion of the coil is accommodated in the at least one opening portion.

13. The motor according to claim 12, wherein a circumferential position of each of the plurality of connecting land portions is substantially equal to a circumferential position of the coil.

14. The motor according to claim 1, wherein the through hole is arranged at a position radially inward of each of the plurality of connecting land portions at the circuit board, and a radial notch extending outwardly is arranged at the through hole.

15. The motor according to claim 14, wherein the radial notch becomes wider the farther away from the rotational axis the radial notch is located.

16. The motor according to claim 1, wherein an external connecting land portion is arranged at a bottom surface of the circuit board.

17. The motor according to claim 5, wherein a substantially flat top surface of the attachment board opposed to the circuit board in the axial direction is substantially parallel to the circuit board, the bottom facing surface of the circuit board and the top surface of the attachment board make contact with each other via an insulating layer, and an axially lowermost position of the solder is arranged axially above the bottom facing surface of the attachment board.

18. The motor according to claim 1, wherein the stator portion includes a thrust bearing portion arranged to rotatably support the rotor portion in the axial direction, and the rotor portion includes a shaft rotating centered about the rotational axis, a rotor magnet arranged to rotate with the shaft, a rotor holder having a substantially cylindrical shape for retaining the rotor magnet, a disk loading portion arranged above the rotor holder to load thereon an optical disk, and a chucking device arranged to retain the optical disk.

19. The motor according to claim 1, wherein a coil is defined by multiply winding the wires correspondingly around a plurality of tooth portions, and an outer circumferential edge of the through hole is arranged radially outward of an outer circumferential edge of the coil.

20. The motor according to claim 1, wherein a coil is defined by multiply winding the wires correspondingly around a plurality of tooth portions, and an outer circumferential edge of the at least one opening portion of the attachment board is arranged radially outward of an outer circumferential edge of the coil.
